(19) United States
(12) Patent Application Publication
(10) Pub. No.: US 2006/0026174 A1
(43) Pub. Date: Feb. 2, 2006

(54) Patent mapping

(76) Inventors: Steven W. Lundberg, Minneapolis, MN (US); Janal M. Kalis, Minneapolis, MN (US); Pradeep Sinha, Medina, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/710,656

(22) Filed: Jul. 27, 2004

(51) Int. Cl. G06F 7/00

(52) U.S. Cl. 707/100

(57) ABSTRACT

The present inventive subject matter provides systems, methods, software, and data structures for patent mapping, storage, and searching. Some such embodiments include mapping patent documents, claims, and claim limitations. Some further embodiments provide for searching a universe of patent documents by patent document, claim, limitation, class, or element.

### TECHNICAL FIELD

The inventive subject matter relates to patent mapping and more particularly to systems, software, methods and data structures for patent mapping.

### BACKGROUND ART

Tools for identifying patents for a particular purpose such as a prior art search, validity analysis, or a freedom to operate investigation, operate by performing Boolean queries using various search operators. These operators allow for searching by date, terms, document number, and patent classification, among others. These tools further allow for searching individual document portions such as a document title, abstract, or claim set.

Other searching tools accept freeform text. Such tools accept a freeform text block and extract information from the text block deemed most likely to return acceptable results. However, such tools are still limited to only performing Boolean queries and displaying a list of results.

These search tools often provide large numbers of results, most of which are irrelevant. These tools fail to present results in a manner allowing for quick relevancy determinations. The presentation also fails to provide enough detail suggesting how to adjust a search for obtaining only relevant results. Further, the search tools provide the documents of the result set in a manner very similar to the traditional paper format of the documents.

### BRIEF DESCRIPTION OF THE DRAWINGS

FIG. 1 is a functional block diagram of one example embodiment.

FIG. 2 is a system schematic diagram of one example embodiment.

FIG. 3 is a method flow diagram of one example embodiment.

FIG. 4 is a method flow diagram of one example embodiment.

FIG. 5 is a method flow diagram of one example embodiment.

FIG. 6 is a method flow diagram of one example embodiment.

FIG. 7A-7I are data structure illustrations according to example embodiments.

FIG. 8 is a method flow diagram of one example embodiment.

### DISCLOSURE OF INVENTION

The inventive subject matter provides systems, software, methods, and data structures for patent mapping, searching, and display to quicken analysis of patent documents for virtually any purpose. Various example embodiments of the inventive subject matter assist practitioners in producing higher quality work product by reducing irrelevant search results, leaving more time and money to focus on the more important analysis. Some further embodiments assist in analysis by interweaving patent documents and linking various portions of individual patent documents with other portions of the same document. Yet further embodiments assist in analyzing patent documents by identifying similarities and differences between one or more patent documents or portions thereof.

In the following detailed description, reference is made to the accompanying drawings that form a part hereof, and in which are shown by way of illustration specific embodiments in which the inventive subject matter can be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

The inventive subject matter herein, in one example embodiment is useful to conduct a patent clearance study to clear a large number of components and assemblies of interest. Such a large scale clearance project presents a number of challenges and opportunities.

When performing such a study of a large number of patents, the same patents need to be screened many times against a wide range of assemblies and components. This can lead to considerable wasted effort unless a well structured approach is taken. Further, The sheer volume of the work creates a special incentive to devise a triage system of review, wherein as much of the work as possible can be done by the least expensive resources. Efficient methodologies of review can be implemented using the inventive subject matter to not only produce relevant results, but also to control cost.

Projects, such as patent clearance studies, often do not capture knowledge that can be re-used as a resource at a later point in time either within the parameters of the clearance study or for other purposes. The inventive subject matter provides a process and system that retains at least some of the knowledge gained through the study, in an accessible manner.

In the present example embodiment, a pool of patents to be mapped and screened is identified using various techniques. Some such techniques include identifying patents by assignee, patent class, keyword searches, inventor information such as name or city and state of residence, title, or other information within patents or patent applications or other source of data related to patent documents. New patents or applications can be added or subtracted from this pool while mapping is in progress, or at a later date when the patent pool or clearance study is updated.

In some embodiments, depending on the requirements of a patent clearance study, at least the independent claims of each patent within the identified patent pool will be mapped. In some embodiments, the mapping includes assigning a patent claim to a concept class, such as a genus, that is broad enough to encompass the broadest possible reading of the claim. For example, if the claim is directed to a dog with a red tail, the concept, or genus, may be dog, or a mapper may assign it to the concept animal, depending on preferences, experience, breadth of the clearance study, or requirements.

After the claim is mapped to a concept, the limitations and relational elements are mapped. First, limitations of interest in the claim are identified. In some embodiments, not all limitations need be mapped. Limitations of interest are highlighted, or otherwise selected or annotated. The highlighted limitations are then mapped, or associated, with one or more reusable concepts kept in a concept catalog or index or other data unit. If the catalog does not contain a suitable concept to map to, a new concept is added to the catalog. Periodically the catalog is reviewed and similar concepts are merged together when possible to limit the size of the concept catalog. In some embodiments, a patent claim with one or two particularly narrow limitations may only require mapping of the one or two limitations.

Within any given patent there are often many claims with similar limitations. Once a claim is mapped, the mapping software will analyze each successive claim chosen for mapping and suggest mappings based on the way other claims in the patent are mapped. Automated suggestions will also be made using mappings established for other patents. Using this tool, mapping is both greatly accelerated and also made more uniform.

In some embodiments, a screening tool is used to rule out patents that are not of interest. A claim to be mapped may be any patentable subject matter, such as a method, apparatus, or composition of matter. In some embodiments, the process of using the screening tool includes opening a screening activity and identifying a claim to be screened. The identified claim is assigned to one or more concepts. The one or more concepts are then used to identify a pool of patents to screen the claim against. The concepts associated with the identified pool of patents to be screened are assembled into a concept pool for use in screening the patents in view of the claim. A screener then reviews the concepts of the patent pool, ruling out any concepts that are not found in the claim. Concepts may be marked as “definitely not in claim”, “maybe in claim”, or “don't know.” If a concept is marked “definitely not found in claim”, then any claim mapped to that concept may be ruled out. If desired, in a software implementation, the inventive subject matter may require multiple concepts to be ruled “definitely not found” for any given claim to be ruled out.

In order to speed screening, the concepts in the pool being mapped will be reduced as follows. Once a concept is marked “definitely not in claim”, the screening software rules out all claims including the ruled out concept are identified. Any concepts that appear only in the ruled out claims are then marked “removed from consideration.” Some embodiments also include annotating ruled out claims as to why the claims were removed (i.e., which claim was ruled out to eliminate them). All concepts belonging to ruled out claim are then removed from the pool of concepts to be screened. Using this process, the pool of concepts to be reviewed is reduced both by the action of ruling out concepts and by the corresponding reduction of claims remaining in the pool of potential patent issues.

In some embodiments, once all concepts in the concept pool are reviewed, there are assorted outputs. The first output includes a record of the screening. The record of the screening includes marking each concept with a status, such as: “definitely not in claim”, “maybe in claim”, “don't know”, or “removed from consideration.” This record can be revisited or reviewed or edited. The second output includes a list of claims that are not applicable to the clearance study. For example, any claim ruled out is added to the list of claims that are not applicable to the subject of the clearance study. This list flows from the status of each concept and in turn the claims the concept belongs to. The third output includes a list of patents that are not applicable to the clearance study. Any patent with all claims ruled out is added to this list of non-applicable patents. This list flows from the status of each claim within a patent. The third output includes a list of all claims that are not definitively ruled out. This is a list of all claims that are not definitively ruled out in the screening process. The fourth output is a list of patents not ruled out. This is a list of all patents that are not definitively ruled out in the screening process.

In some embodiments, mapping of patents and claims is semi-automated. In addition, mapping personnel can be trained to identify esoteric or very narrow limitations in claims and map only those limitations. This reduces mapping time for inherently narrow patent claims. To screen out possibly applicable patents, the process only requires that limitations be mapped to a concept that is at least as broad as the limitation.

Screening can also be accomplished in reverse. That is, concepts applicable to the subject of the screening can be identified as “present” or “maybe present” in a claim. This process will identify potential claims that cover the subject of the screening. However, this process may require that all limitations in a claim be mapped accurately to concepts.

In some embodiments, software and systems, according to the inventive subject matter herein, is web-based and accessible with a user name and password. Subscribers to such systems and software receive a license to use the software for an individual project, a period of time, or on a pay-per-access or pay-per-unit of time basis.

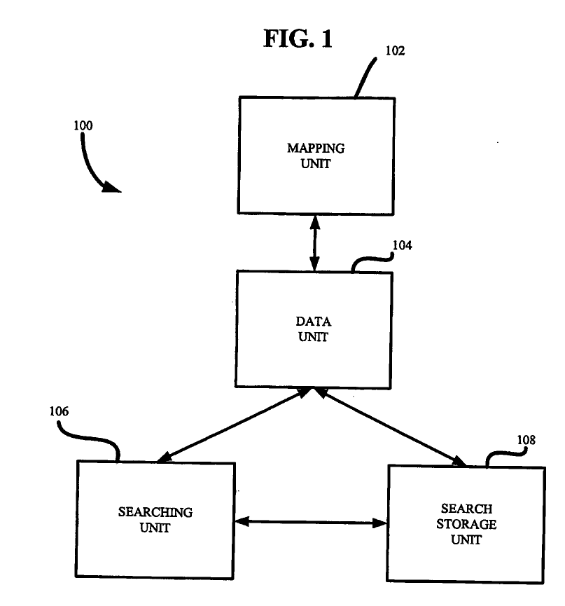

FIG. 1 shows a functional block diagram of one example embodiment of the inventive subject matter. This example embodiment illustrates software 100 for mapping and searching for patent documents. In some embodiments, the patent documents include one or both of patents and published patent applications. In some embodiments, the patent documents include United States patent documents, while other embodiments include international patent documents. The software 100 for mapping these patent documents includes a mapping unit 102, a data unit 104, a searching unit 106, and a search storage unit 108.

In some embodiments of the software 100, the mapping unit 104, the searching unit 106, and the search storage unit 108 work with associations of data between various portions of patent documents. Some such associations include two patent claim definitional elements associated with a relational element. An example of such an association is, “A dog wags its tail.” The two definitional elements are “dog” and “tail.” The relational element is “wags.” Some patent claims may contain many of such associations. For example, “A dog wags its tail that is brown.” The first association is the same as before. The second association is between definitional elements “tail” and “brown.” The second relational element is “is.” “Is” in this context equates to “has color.” Such associations can also be included between a claim, or portion thereof, and a portion of a patent disclosure providing support for the claim.

In some further embodiments of the software 100, the mapping unit 102, the data unit 104, the searching unit 106, and the search storage unit 108 work with one or more classes of all or a portion of a patent document. In some embodiments, a class is a technology area, such as computers, or a component, such as a processor, or a concept, such as a genus, encompassing all or a portion of a patent claim. A class can also be relational, such as a relationship between elements of a claim.

Some classes are a subclass of a class, such as a processor class that is a subclass of computers. In some such embodiments, a subclass can be designated as an inherent property of a class. In other embodiments, a class definition includes various properties of the class that are inherent, such as a personal computer class having an inherent property of a housing encasing a number of components. Other embodiments include classes that are concepts, such as “storing data” or “electronic funds transfer.” The “storing data” example might include databases, storage devices, or storage media. The “electronic funds transfer” might include banking, money, network, transfer, Federal Reserve, or EFS. Some embodiments of concept class definitions include a glossary of words useful in identifying the concept. Some embodiments include a scoring algorithm for assigning a score to a patent document, or portion thereof, based on the occurrence of glossary words. Some words are worth more points than others are, for example, some words have negative values and others positive, or greater values and lesser values. A greater score in some embodiments is given when certain words appear in a certain order or within a certain proximity of one another.

In some embodiments, the mapping unit 102 operates to abstract a portion of a patent document, such as the patent claims, and mapping the abstracted portion to a class. In some embodiments, abstracted portion is a genus of a claim that is implicit to the claim, but not explicitly stated in the claim. This abstracting in various embodiments includes mapping one or more classes to a claim. In some such embodiments, a class is mapped to one or more claim limitations or elements. The mapping unit 102 then stores mapped patents in the data unit 104. In some embodiments, a mapping utility is included in the mapping unit 102. This mapping utility extracts language from an unmapped patent claim and compares the extracted language against class definitions and previously mapped patent claims to determine a likely classification. In some such embodiments, the mapping utility makes a mapping recommendation through a user interface. In other embodiments, the utility operates in a batch mode and automatically maps patent claims, or other patent document portions.

In some embodiments, the data unit 104 operates to store output from the mapping unit 102 and provide data to the searching unit 106. The data unit 104 also stores data received from the search storage unit 108 and serves data to the search storage unit 108 when requested. In one such embodiment, the data unit 104 includes a database management system (DBMS) for storing and retrieving data. In some embodiments, the DBMS is a relational database management system (RDBMS). In some other embodiments, the data unit 104 includes storing data in a Resource Description Framework Schema (RDFS). In some embodiments, the various units communicate with the data unit 104 using a language such as Structured Query Language (SQL) or extensible Markup Language (XML).

The searching unit 106 includes tools for extracting patent data in a useful manner from the data unit 104. In some embodiments, the starting point for searching is the entire universe of patent documents in the data unit 104. Documents in this universe are eliminated based on input by a searcher. In some embodiments, this input includes eliminating elements or classes from consideration. In some embodiments, when elements or classes are eliminated, patent documents containing only eliminated classes are removed from the universe. In some other embodiments, if a class or element is eliminated, all patent documents including that class are removed from the universe.

The search storage unit 108 performs functions for storing and retrieving search results obtained by the searching unit 106 in the data unit 104. In some embodiments, storing the search results includes storing various parameters used in search including eliminated classes, eliminated elements, or even a list of specific documents excluded from a search. In other embodiments, a listing of identified patent documents is stored. Some such embodiments also store search parameters such as eliminated classes, eliminated elements, search terms or concepts, and relevancy indicators attached to one or more patent documents identified in a search. In some embodiments, a relevancy indicator is attached to a patent document for indicating the relevancy of the document for the purpose of the search. Some example relevancy indicators include marking documents as 35 U.S.C. § 102 or § 103 references when the purpose of the search is a patentability search. Some embodiments provide the ability to create custom relevancy indicators.

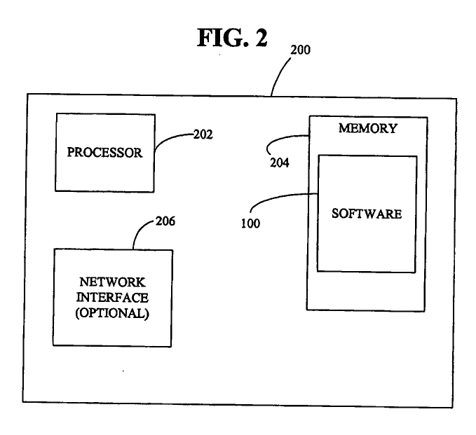

FIG. 2 shows a schematic diagram of a system 200 according to one example embodiment of the inventive subject matter. The system 200 includes a processor 202 and a memory 204 holding the software 100 (as shown in FIG. 1). Some embodiments of the system 200 include an optional network interface 206 for accessing a network during execution of the software 100. In some such networked embodiments, the system is a client/server system where various portions of the software 100 are distributed across a network for performing various tasks required by the software. In some other networked embodiments, the system is a web-based system with software distributed across a network, such as a local or wide area network, an intranet, or the Internet, with various portions of the software distributed across the network. In some such web-based systems, a client computer causes the software 100 to execute through interaction with the software 100 through a client user process such as a web browser.

In some embodiments, the processor 202 represents a central processing unit (CPU) of any type of architecture, such as a CISC (Complex Instruction Set Computing), RISC (Reduced Instruction Set Computing), VLIW (Very Long Instruction Word), or hybrid architecture, although any appropriate processor may be used. The processor 202 executes instructions, such as instructions contained within the software 100. In some other embodiments, the processor is a graphics processor on a video card. The processor 202 in these embodiments also includes a control unit that organizes data and program storage in memory 204 and transfers data and other information in and out of the system 200 and to and from a network over the network interface 206 and other devices attached to the network. Although the system 200 is shown to contain only a single processor 202, the present inventive subject matter applies equally to systems 200 that include multiple processors 202 such as multiple CPUs, multiple graphics processors, and combinations of CPU and graphics processors.

The memory 204 of the system 200 holds the software 100 as illustrated in FIG. 1. The memory 204 represents one or more mechanisms for storing data. For example, the memory 2-4, in various embodiments, includes read only memory (ROM), random access memory (RAM), magnetic disk storage media, optical storage media, flash memory devices, and/or other volatile and non-volatile machine-readable media. In other embodiments, any appropriate type of storage device or memory 204 can be used. Although only one memory 204 is shown, multiple memories 204 and multiple types of storage devices can be present. In various embodiments, some or all of the software 100, or other items, can be stored on the same or on different memory 204 or storage devices. Furthermore, although the system 200 is drawn to contain the memory 204, the memory 204 or other storage device can be distributed across other systems 200 or computing devices operatively coupled to the system 200 over the network interface 206 such as by a network or other wired or wireless communication link such as a network.

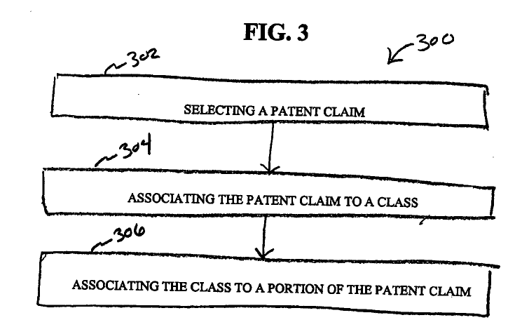

FIG. 3 is a method 300 flow diagram of one example embodiment. The method 300 of this embodiment includes selecting a patent claim 302, associating the patent claim to a class 304, and associating the class to a portion of the patent claim 306. Selecting a patent claim 302 includes selecting a claim from a patent document for mapping.

Associating the patent claim to a class 304 includes assigning a class designation to the claim. Depending on the claim, this assignment might include assigning a class that is a genus of the claim. Some embodiments provide the ability to assign multiple classes to a claim. Associating the class to a portion of the patent claim 306 includes assigning the class to a portion of the claim such as a single limitation, a phrase, an element, or even an individual word within the claim. For example, consider a claim including the limitation, “a dog having a tail.” The word dog could be assigned to a class “mammal” or “canine.” The word “tail” could be assigned to a class “body part” or “appendage.” As a further example, the same limitation could be assigned to a class “dog,” wherein a definition of the class dog includes a tail.

The results of the associating 304 and 306 are stored to provide search users of a system, such as system 200 of FIG. 2, the ability to not only search for patent documents by class or element, but also to search for patent claims and for specific portions of patent claims by class or element. Some such embodiments provide searchers the ability to pin point specific claims and claim language of interest when performing a search as part of a freedom to operate opinion.

Some further embodiments of the method 300 include associating a portion of the patent document, such as a portion of a description section, to a claim. Such an assigned portion, in some embodiments, is a portion of the description providing support for the patent claim, or element thereof. Some embodiments include associating one or more sentences of a description section to an individual claim element. This association information is stored to allow searchers quick reference to support and explanation of the various patent claims and claim elements in the patent documents.

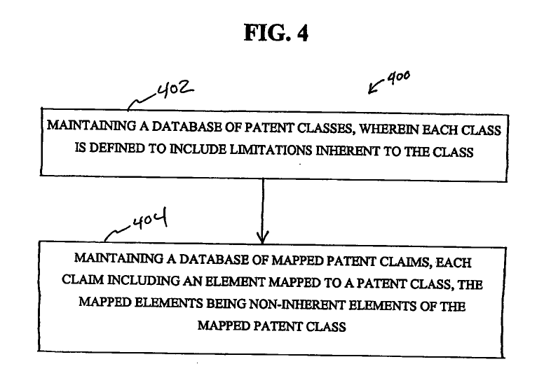

FIG. 4 is a method 400 flow diagram of one example embodiment. The method of this embodiment includes maintaining a database of patent classes, wherein each class is defined to include limitations inherent to the class 402. The method 400 further includes maintaining a database of mapped patent claims, each claim including an element mapped to a patent class 404. Some such embodiments further provide that the mapped elements being non-inherent elements of the mapped patent class. In some embodiments, the mapped patent claims include independent claims and only dependent claims containing elements not inherent to a class mapped to a parent independent claim of the dependent claim.

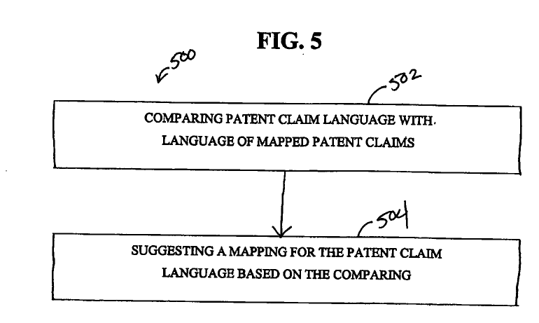

FIG. 5 is a method 500 flow diagram of one example embodiment for assisted patent mapping. The method 500 of this embodiment includes comparing patent claim language with language of mapped patent claims 502 and suggesting a mapping for the patent claim language based on the comparing 504. In some other embodiments, the claim language is classified according to a classification schema. In such embodiments, the claim language is compared against and classified or mapped according to class definitions. In some further embodiments, claim language is compared against both class definitions and previously mapped claim language.

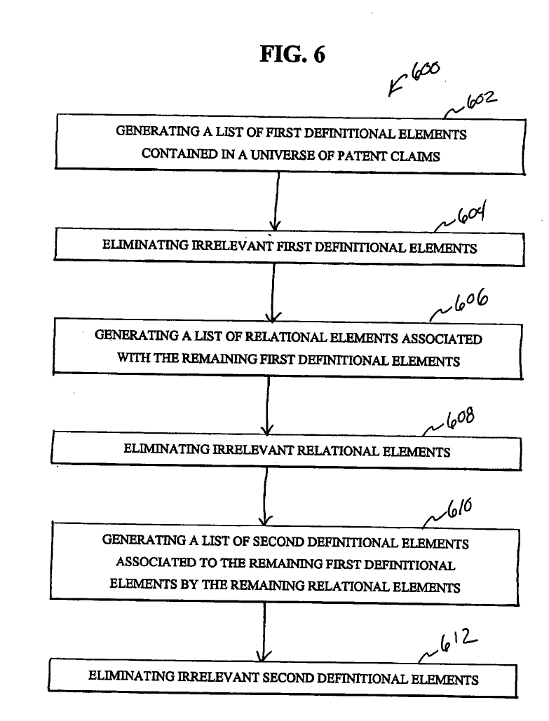

FIG. 6 is a method 600 flow diagram of one example embodiment for searching a universe of patent documents. The method 600 includes generating a list of first definitional elements contained in the universe of patent claims 602 and eliminating irrelevant first definitional elements 604. This embodiment further includes generating a list of relational elements associated with the remaining first definitional elements 606 and eliminating irrelevant relational elements 608. Some embodiments of the method 600 further include generating a list of second definitional elements associated with the remaining first definitional elements by the remaining relational elements 610 and eliminating irrelevant second definitional elements 612. In some embodiments, the definitional elements include elements defining subjects of a claim or claim elements. A relational element relates two definitional elements to one another. An example considering the claim, “A dog wags a tail.” is as follows. The first definitional element is “dog.” The relational element is “wags.” The second definitional element is “tail.”

In some embodiments of the method 600, a first definitional elements associated only with eliminated relational elements are eliminated upon elimination of the relational element. In some further embodiments, relational elements associated only with eliminated second definitional elements are eliminated upon elimination of the second definitional element. For example, consider a first definitional element is associated only with one relational element that is associated with only one second definitional element. Elimination of the second definitional element causes the relational element to be eliminated. Further, this elimination of the relational element causes the first definitional element to be eliminated as well.

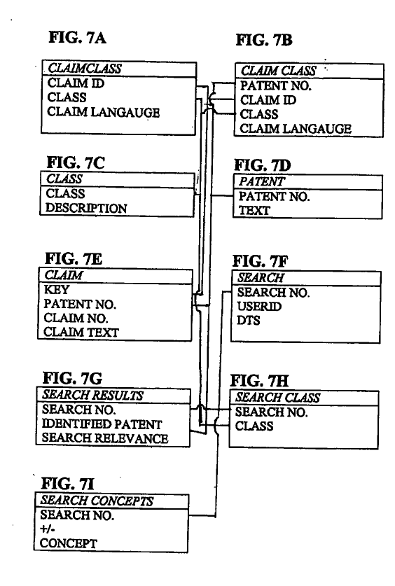

FIG. 7A-FIG. 7I are illustrations of example data structure embodiments useful in practicing various embodiments of the present inventive subject matter. The embodiments illustrated in FIG. 7A-FIG. 7I are shown as database tables for use in a RDBMS as example only. Lines showing relations between the various tables of FIG. 7A-FIG. 7I are included for illustrative purposes as well. However, other data structures useful for carrying out the present inventive subject matter will be readily apparent to one of skill in the art. Further, some data types in the following discussion of the embodiments of FIG. 7A-FIG. 7I are provided as examples and are not to be considered limiting.

FIG. 7A and FIG. 7B illustrate example embodiments of data structures for associating a patent claim to a class. FIG. 7A is a database table named ClaimClass. This table includes three columns: Claim ID, Class, and Claim Language. The Claim ID column holds data representing a patent claim. The value stored in the Claim ID column is an arbitrary identifier, such as a unique number, assigned to a claim for use as an identifier. This identifier is assigned to a claim when entered into a table storing claims, such as the Claim table illustrated in FIG. 7E. The Class column holds data associating the patent claim of the Claim ID column to a class. The Claim Language column holds a value associating the class of the Class column to a portion of the claim of the Claim ID column of a row. For example, if the class held in the Class column is for only a portion of the claim, the language of that portion of the claim, in some embodiments, is held in the Claim Language column. In other embodiments, a reference to the claim language is stored in the Claim Language column. For example, if the claim is stored in another table of the database, a reference to the record in that other table will be stored in the Claim Language column along with an indicator of the location of the text within the table.

FIG. 7B illustrates an alternate embodiment of the ClaimClass table. For the sake of brevity, only the difference between the table of FIG. 7A and the present table will be discussed. The present ClaimClass table includes a Patent No. column. This column stores a value referencing the specific patent the claim identified a row is from. This value, in some embodiments is an official patent number. In other embodiments, the column stores a value that is a key or index into another table storing the patent, such as the Patent table of FIG. 7D. Some further embodiments, not shown in FIG. 7B, include a column for associating the claim language specified in the Claim Language column to a portion of a description contained in a patent document providing support for the claim. In some embodiments, this includes a column and line number citation to an official patent document. In other embodiments, this includes a reference to a specific position or range of positions in an electronically stored copy of the patent document.

FIG. 7C illustrates an example embodiment of a data structure for storing class definitions. This embodiment functions as a lookup table named Class. The Class table has a Class column and a Description column. The Class column holds an identifier for a class. In some embodiments, this is a unique identifier assigned by the RBMS to each row. In other embodiments, the Class column holds a short name for a class. Either way, or other similar ways, a value in the Class column is used as a key into the Class table from other tables such as from the ClaimClass table.

Each row in the Class table is a class definition. A class can be defined as a field of technology, a type of device, a concept, or virtually anything imaginable for classifying a patent document. Some embodiments of the Class table include a glossary column or another associated table for storing a glossary of words pertinent to a class definition. In some embodiments, the glossary words are useful in identifying patent documents, claims, or claim limitations as pertinent to a particular class.

FIG. 7D illustrates an example embodiment of a data structure for storing patent data. In one embodiment, the data structure is a database table named Patent. In this embodiment, the table has two columns, Patent No. and Text. Patent No. hold a value for identifying a patent. This value can be an official patent number or any other unique number useful for identifying a particular patent document. The Text column holds the text of a patent document. In some embodiments, the Text column is a BLOB data type. In other embodiments, the Text column is a text data type. The data type of a particular embodiment depends on the data structure type, DBMS type, version, and brand, and other factors pertinent to a specific embodiment. Some other embodiments include further columns such as a section column, providing the ability for a patent document to be stored with each document section having a row in the table. Yet further embodiments provide a column for hold a value representative of a country the patent document is issued by. This provides the ability for using various embodiments of the present inventive subject matter as described herein for classifying and searching international patent document simultaneously.

FIG. 7E illustrates an embodiment example of a data structure for storing claim data. This embodiment includes a database table named claim. The Claim table includes a Claim ID column, a Patent No. column, a Claim No. column, and a Claim Text column. This stores a claim with the text of a claim in the Claim Text column and claim number in the Claim No. column. The Patent No. column holds a value representative of a patent document. This value in some embodiments includes an official patent number. In other embodiments, this value is a key to a row in another database table storing more data about the specific patent the claim of a row is from. The Claim ID column is a key to identify a particular row in the Claim table. This value can be used by other tables, such as the ClaimClass table of FIG. 7A, to reference a row in the Claim table.

FIG. 7F illustrates an example embodiment of a data structure for storing data related to a patent document search. This embodiment includes a database table named Search. This table includes a row for each search that is saved. The columns include Search No., Userid, and DTS (date/time stamp). The Search No. column holds a unique identifier of a search that is saved. The value held in the Search No. column is used to link together multiple rows in multiple tables in the database storing data about a save search. The Userid column stores a value representative of who or what process performed a search. The DTS column stores a date and time of when the search was performed.

FIG. 7G illustrates an example embodiment of a data structure for storing search results. This embodiment includes a database table named Search Results. The Search Results table contains rows, one row for each identified patent document of a search. The columns in this embodiment of the table include Search No., Identified Patent, and Search Relevance. The Search No. in some embodiments is a key for indexing into or from the Search table of FIG. 7G to relate rows between the tables. The Identified Patent column is a value representing a patent document identified in a search. The value in this column in some embodiments is a patent number of a patent. In other embodiments, this value is a key for indexing into another table such as the Patent table of FIG. 7D. The Search Relevance column of the table holds a value representative of the relevance of the identified patent document for the purpose of a search. For example, this value might indicate the document is a 35 U.S.C § 102 or § 103 reference if the search is performed for purposes of a validity opinion or patentability search. Some embodiments provide searchers the ability to create and use custom relevancy indications. Some embodiments of the present inventive subject matter utilize a lookup table for storing various relevancy options. In such embodiments, an key value from the lookup table is stored in the Search Relevance column of the Search Results table for indicating the relevancy of a patent document represented in a row of the table.

FIG. 7H illustrates an example embodiment of a data structure for storing classes either used or eliminated from consideration in a saved search. This embodiment includes a database table named Search Class. The columns of this table include Search No. and Class. The Search No. in some embodiments is a key for indexing into or from the Search table of FIG. 7G to relate rows between the tables. The class column contains a value representative of a class used to group patent documents. In some embodiments, the value in this column is a key value from the Class table of FIG. 7C.

FIG. 7I illustrates an example embodiment of a data structure for storing concepts utilized in performing a saved search. This embodiment includes a database table named Search Concepts. This table includes a row for each concept used in a save search. This table includes columns Search No., +/−, and Concept. The Search No. in some embodiments is a key for indexing into or from the Search table of FIG. 7G to relate rows between the tables. The +/−column indicates whether to include only documents including a concept or exclude documents including the concept. The Concept column is the concept to include or exclude from the search results.

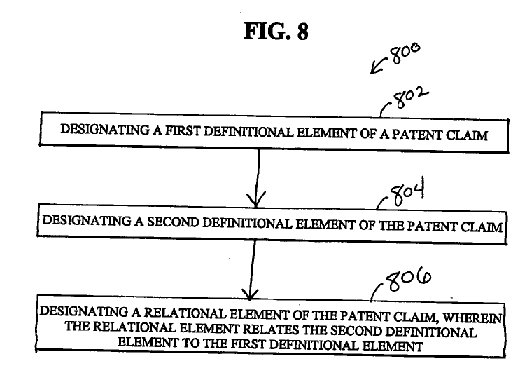

FIG. 8 is a method 800 flow diagram of one example embodiment. The method 800 includes designating a first definitional element of a patent claim 802, designating a second definitional element of the patent claim 804, and designating a relational element of the patent claim, wherein the relational element relates the second definitional element to the first definitional element 806.

In some embodiments, designating an element of a patent claim as a definitional element or a relational element includes designating at least a portion of a patent claim as such. For example, a first definitional element, commonly a subject of a patent claim, is designated. The second definitional element, commonly an object of a patent claim, is designated and stored with a patent mapping. Then the relational element, commonly a predicate of a patent claim, is designated. An example is, “A dog with a tail.” “Dog” is the first definitional element or subject of the claim. “Tail” is the second definitional element or object of the claim. “With” is the relational element, or predicate, of the claim and specifies the relationship between first and second definitional elements, or the subject and the object, or the claim.

It is understood that the above description is intended to be illustrative, and not restrictive. Many other embodiments will be apparent to those of skill in the art upon reviewing the above description. The scope of the inventive subject matter should, therefore, be determined with reference to the appended claims, along with the full scope of equivalents to which such claims are entitled.

1. A data structure comprising: a first field containing data representing a first portion of a patent claim; a second field containing data representing a second portion of a patent claim; and a third field containing data representing a third portion of a patent claim, wherein the third field associates the first field to the second field.

2. The data structure of claim 1, further comprising: a fourth field containing data associating the patent claim of the first field to a patent disclosure providing support for the portion of the claim in the third field.

3. The data structure of claim 2, wherein the association of the fourth field includes a citation to a portion of the patent disclosure.

4. The data structure of claim 2, wherein the association of the fourth field includes a text of the patent disclosure.

5. The data structure of claim 1, wherein the first, second, and third fields contain text of the patent claim.

6. The data structure of claim 1, wherein the second field contains data representative of a class defined in another data structure.

7. The data structure of claim 6, wherein the another data structure is a lookup table.

8. A method comprising: designating a first definitional element of a patent claim; designating a second definitional element of the patent claim; and designating a relational element of the patent claim, wherein the relational element relates the second definitional element to the first definitional element.

9. The method of claim 8, wherein designating the first definitional element of the patent claim includes designating at least a portion of the patent claim as the first definitional element.

10. The method of claim 9, wherein designating the second definitional element of the patent claim includes designating at least a portion of the patent claim as the second definitional element.

11. The method of claim 8, wherein designating the first and second definitional elements and the relational element of the patent claim includes assigning a class to each of the elements.

12. The method of claim 8, further comprising: associating the patent claim to a patent disclosure providing support for the patent claim.

13. The method of claim 12, wherein associating the patent claim to a patent disclosure providing support for the patent claim comprises: associating the relational element to a portion of the patent disclosure.

14. The method of claim 13, wherein the associating the relational element of the patent claim to a portion of the patent disclosure comprises: associating one or more words of the patent claim to one or more sentences of the patent disclosure.

15. A method comprising: maintaining a database of patent classes, wherein each class is defined to include elements inherent to the class; and maintaining a database of mapped patent claims, each claim including an element mapped to a patent class, the mapped elements being non-inherent elements of the mapped patent class.

16. The method of claim 15, wherein each of the mapped patent claims is an independent claim.

17. The method of claim 15, wherein the mapped patent claims do not include a dependent claim containing only elements inherent to a class mapped to a parent claim of the dependent claim.

18. A method comprising: comparing patent claim language with language of mapped patent claims; and suggesting a mapping for the patent claim language based on the comparing.

19. A method comprising: generating a list of first definitional elements contained in a universe of patent claims; eliminating irrelevant first definitional elements; generating a list of relational elements associated with the remaining first definitional elements; eliminating irrelevant relational elements; generating a list of second definitional elements associated to the remaining first definitional elements by the remaining relational elements; and eliminating irrelevant second definitional elements.

20. The method of claim 19, wherein first definitional elements only associated with eliminated relational elements are eliminated and wherein relational elements only associated with eliminated second definitional elements are also eliminated.

21. A computer readable medium, with instructions thereon, for causing an appropriately configured computer to: generate a list of elements contained within a universe of patent claims; and eliminate elements, wherein eliminating an element present in a patent claim eliminates patent claims depending therefrom.

22. The computer readable medium of claim 21, wherein the elements comprise definitional elements and relational elements.
